(19) United States
(12) Patent Application Publication
(10) Pub. No.: US 2010/0320095 A1
(43) Pub. Date: Dec. 23, 2010

(54) DEVICE FOR MONITORING WATER QUALITY

(76) Inventors: Natan Galperin, Zoran (IL); Tzur Ben-David, Ramat Hasharon (IL)

Correspondence Address: LADAS & PARRY LLP, 224 SOUTH MICHIGAN AVENUE, SUITE 1600, CHICAGO, IL, 60604, US

(21) Appl. No.: 12/740,253

(22) PCT Filed: Oct. 27, 2008
(86) PCT No.: PCT/IB2008/054428

§ 371 Date: Sep. 1, 2010

Related U.S. Application Data
(60) Provisional application No. 60/983,298, filed on Oct. 29, 2007.

(51) Int. Cl. G01N 27/30

(52) U.S. Cl. 205/778.5; 204/431

(57) ABSTRACT

A device for monitoring chlorine in water, the device comprising a chlorine sensor adapted to measure a chlorine concentration in water; and a controller adapted to facilitate conversion between an active mode during which water analysis may be performed, and a low energy sleep mode in which the chlorine sensor is still energized but water analysis may not be performed. In sleep mode, a polarization voltage is maintained on an electrode comprised in chlorine sensor, which allows for a substantial reduction in a stabilization time required by the electrode following connection to an energy source after having been disconnected. Conversion between the active mode and the sleep mode may be according to predetermined parameter such as, for example, a predetermined time period, upon receipt of an indication from a independent timer, or by remote initiation from an external source.

### FIELD

The invention relates to a device and a method for monitoring water quality.

### BACKGROUND

Drinking water is a potential source of numerous diseases and infections afflicting humans, some of which may even be lethal. Some well known examples include cholera, dysentery and typhoid. To substantially reduce the risk of contraction of diseases and infections, drinking water is generally treated with chlorine in water treatment plants prior to distribution for human consumption. The chlorine acts as a disinfectant, killing numerous bacteria and viruses found in water by bonding to, and destroying, their outer surfaces.

Chlorine in the water treatment plant is generally added into water as chlorine gas, sodium hypochlorite and/or chloride dioxide. Monitoring of a concentration of chlorine is usually performed both in the plant and in monitoring stations located at various points in a water distribution network. Monitoring is performed to ensure that the chlorine concentration in the drinking water is maintained below a level which may pose a hazard for human consumption, yet above a minimum level necessary to substantially eliminate possible bacteria and viruses. Levels of chlorine concentration in water are generally controlled by government regulations in each country, and may vary from country to country. In some countries, the levels are regulated by state or provincial governments, while in some others, municipal governments regulate the levels. Typically, drinking water should contain chlorine concentration of 2 to 3 part per million (ppm), although levels ranging from 0.5-10 ppm may be considered acceptable.

Measurement of chlorine concentration in the monitoring station is generally done using any one of, or any combination of, the following methods: DPD (N, N-Diethyl-p-Phenylenediamine) method, Iodide method, and Amperometric method.

a. The DPD method generally comprises the use of a DPD automatic system or, alternatively, the use of a handheld kit. When using the handheld kit, a user takes a water sample, mixes the chemical DPD into the sample, and then visually compares the color of the mixture with a color chart which lists increasing chlorine levels according to a color gradient. The automatic system operates using the same principle of comparing the color of the mixture with a color chart, with the variation that all processes are automatically performed by the DPD automatic system.
b. The Iodide method typically comprises the use of a sensor connected to a water pipe, the sensor adapted to collect water samples which are mixed with DPD comprised in the sensor. The chlorine level in the water is then determined by processing a signal from an optical sensing element comprised in the sensor.
c. The Amperometric method typically comprises the use of a sensor connected to a water pipe, the sensor generally comprising an electrode with a membrane, which the water flows by. The chlorine ion (HOCl) passes through the membrane to produce an electric current in the electrode. Signal processing is performed on the current so as to determine the chlorine concentration in the water. Generally, a larger current is associated with a greater concentration of chlorine.

### SUMMARY

An aspect of some embodiments of the invention relates to providing a method and a device for monitoring of water quality; the device may be adapted to work in low and/or normal power consumption and/or in low maintenance environments. The device is further adapted for use in both populated and remote geographical areas and/or in any environment.

Devices for monitoring water quality are known in the art. Many use commercially available sensors to measure water pH, water temperature, and chlorine concentration in the water. Generally, these devices are limited for use in geographical areas serviced by electric power lines or solar panels, as the power requirements of the devices are rather high when constant monitoring of water quality is required. As a result, none of these devices can be used in urban areas where electricity is not available under main road a few meters in the ground, requiring that water quality checks in these areas be conducted by trained personnel, typically using handheld testing kits. A problem frequently encountered with trained personnel conducting the water quality checks is that the frequency with which the personnel may reach remote monitoring or underground stations may be limited and, therefore, the quality of the water may not be properly monitored.

Chlorine sensors, such as, for example, Amperometric-type sensors, comprise electrodes which may suffer from out of scale reading as a result of continuous exposure to relatively low chlorine levels for long time (more than a week). Relatively low chlorine levels may occur when there is not enough chlorine in the water. As a result, in areas where personnel visit the monitoring station relatively infrequently, one may assume that the frequency of breakdowns in the devices is relatively high as the quality of the water is not regularly monitored. This is in addition to the potential health hazards posed by substantially low chlorine concentrations in the water.

According to an aspect of some embodiments of the invention there is provided a device for monitoring chlorine in water, the device adapted to measure chlorine concentration in the water and to disconnect a chlorine sensor when the concentration is below a predetermined value, such as, for example 0.03 ppm. Optionally, the device is adapted to measure water flow rate (value) and to disconnect the chlorine sensor when the water flow rate is below a predetermined value, such as, for example, 25 liters per hour (l/h). The device is optionally adapted to measure chlorine concentration and/or water flow rate more than once over a predetermined period of time, and to disconnect the sensor if chlorine concentration and/or flow rate are below the predetermined value. Optionally, the device is adapted to measure chlorine concentration and/or water flow rate non-periodically, and/or when remotely initiated by a source external to the device.

According to an aspect of some embodiments of the invention, the method provides for a low energy sleep mode wherein the device disconnects power to most functions in the sensor while maintaining energized an electrode which is comprised in the sensor. By maintaining the electrode energized, a stabilization time, of relatively extended length, which is generally required to return the electrode to operation after being de-energized, is saved. Usually, most functions in the sensor are operating during the stabilization time, substantially increasing device power consumption. In the sleep mode of operation the sensor is woken up relatively quickly whenever required for making measurements, and then returns to sleep, substantially reducing device power consumption. Additionally, the method provides for a shut down mode wherein the device disconnects power to most functions in the sensor, including the electrode. When power is connected back to the electrode, the sensor is generally ready for measurements after the stabilization time. Measurements are performed during an active mode of operation, when most functions in the sensor are powered.

In accordance with an embodiment of the invention, the device comprises: a sampling cell to which water is bypassed from a pipe conducting water for measurement purposes; a chlorine sensor; a pH sensor; a water temperature sensor; a flow sensor; a controller and associated electronic circuitry; a communications module for remote wireless, optionally wired, communications; a power module comprising a battery package and, optionally, a means to connect to other alternating current (AC) or direct current (DC) power sources.

In accordance with an embodiment of the invention, there is provided a device for monitoring chlorine in water, the device comprising a chlorine sensor adapted to measure a chlorine concentration in water; and a controller adapted to facilitate conversion between an active mode, during which water analysis may be performed, and a low energy sleep mode in which the chlorine sensor is still energized, but water analysis may not be performed. In sleep mode, a polarization voltage is maintained on an electrode comprised in a chlorine sensor, which allows for a substantial reduction in a stabilization time required by the electrode following connection to an energy source after having been disconnected. Conversion between the active mode and the sleep mode may be according to predetermined parameters such as, for example, a predetermined time period, upon receipt of an indication from an independent timer, or by remote initiation from an external source.

In accordance with some embodiments of the invention, the controller is further adapted to disconnect the chlorine sensor upon receiving a signal indicative of the chlorine concentration being at or below a predetermined value. Optionally, the controller is further adapted to receive a second signal indicative of a chlorine concentration in water after a predetermined period of time, upon receiving the signal indicative of the chlorine concentration being at or below the predetermined value. The controller is adapted to disconnect the chlorine sensor if the second signal is indicative of the chlorine concentration being at or below the predetermined value. Additionally, the controller is further adapted to disconnect the chlorine sensor upon receiving a signal indicative of a water flow value being at or below a predetermined value. Additionally, the controller is further adapted to connect the chlorine sensor after the predetermined period of time.

According to some embodiments of the invention, the controller is further adapted to receive a second signal indicative of a chlorine concentration in water after a predetermined period of time. Upon receiving a first signal indicative of the chlorine concentration being at or below a predetermined value. The controller is adapted to disconnect the chlorine sensor if the second signal is indicative of the chlorine concentration being at or below the predetermined value. Additionally, the controller is further adapted to connect the chlorine sensor after a predetermined period of time.

In accordance with an embodiment of the invention, there is provided a device for monitoring chlorine concentration in water, the device comprising a chlorine sensor adapted to measure chlorine concentration in water; and a controller adapted to disconnect the chlorine sensor upon receiving a signal indicative of a chlorine concentration in water being at or below a predetermined value.

In some embodiments of the invention, the controller is further adapted to facilitate periodic conversion between an active mode and a sleep mode, wherein the conversion depends on a predetermined parameter. Optionally, the controller is further adapted to disconnect the chlorine sensor upon receiving a signal indicative of a water flow value being at or below a predetermined value. Additionally, the controller is further adapted to connect the chlorine sensor upon receiving a signal indicative of a water flow value being at or above a predetermined value.

In accordance with some embodiments of the invention, the controller is further adapted to facilitate periodic conversion between the active mode and the sleep mode, wherein the conversion depends on a predetermined parameter. Optionally, the controller is further adapted to connect the chlorine sensor after a predetermined period of time.

In accordance with some embodiments of the invention, the chlorine sensor comprises a chlorine sensing electrode.

In accordance with an embodiment of the invention, there is provided a method for monitoring chlorine in water, the method comprising measuring chlorine concentration in water using a chlorine sensor; and converting between an active mode, during which water analysis may be performed, and a low energy sleep mode in which the chlorine sensor is still energized but water analysis may not be performed. In sleep mode, a polarization voltage is maintained on an electrode comprised in a chlorine sensor, which allows for a substantial reduction in a stabilization time required by the electrode following connection to an energy source after having been disconnected. Conversion between the active mode and the sleep mode may be according to predetermined parameters such as, for example, a predetermined time period, upon receipt of an indication from an independent timer, or by remote initiation from an external source.

According to some embodiments of the invention, the method provides for the controller disconnecting the chlorine sensor upon receiving a signal indicative of the chlorine concentration being at or below a predetermined value. Optionally, the method provides for the controller disconnecting the chlorine sensor upon receiving a second signal indicative of the chlorine concentration in water being at or below the predetermined value, after a predetermined period of time upon receiving the first signal indicative of the chlorine concentration being at or below the predetermined value. Additionally, the method provides for the controller disconnecting the chlorine sensor upon receiving a signal indicative of a water flow value being at or below a predetermined value.

In accordance with some embodiments of the invention, the method provides for the controller disconnecting the chlorine sensor upon receiving a signal indicative of the chlorine concentration being at or below a predetermined value. Optionally, the method provides for the controller connecting the chlorine sensor upon receiving a signal indicative of the chlorine concentration being above a predetermined value.

In some embodiments of the invention, the method provides for the controller disconnecting the chlorine sensor upon receiving a second signal indicative of the chlorine concentration in water being at or below a predetermined value, after a predetermined period of time upon receiving a first signal indicative of the chlorine concentration being at or below a predetermined value. Optionally, the method provides for the controller connecting the chlorine sensor after a predetermined period of time.

In accordance with an embodiment of the invention, there is provided a method for monitoring chlorine concentration in water, the method comprising measuring chlorine concentration in water using a chlorine sensor; and disconnecting the chlorine sensor upon a controller receiving a signal indicative of a chlorine concentration in water being at or below a predetermined value.

In some embodiments of the invention, the method provides for the controller facilitating periodic conversion between an active mode and a sleep mode, wherein the conversion depends on a predetermined parameter. Optionally, upon receiving a signal indicative of a water flow value being at or below a predetermined value, the method provides for the controller disconnecting the chlorine sensor. Additionally, after a predetermined period of time, the method provides for the controller connecting the chlorine sensor.

In some embodiments of the invention, the method provides for the chlorine sensor comprising a chlorine sensing electrode.

### BRIEF DESCRIPTION OF FIGURES

Examples illustrative of embodiments of the invention are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIG. 1 schematically shows a block diagram of an exemplary device for monitoring water quality, in accordance with an embodiment of the invention; and,

FIG. 2 schematically shows a flow diagram of a method of using the exemplary device of FIG. 1, in accordance with an embodiment of the invention.

### DETAILED DESCRIPTION

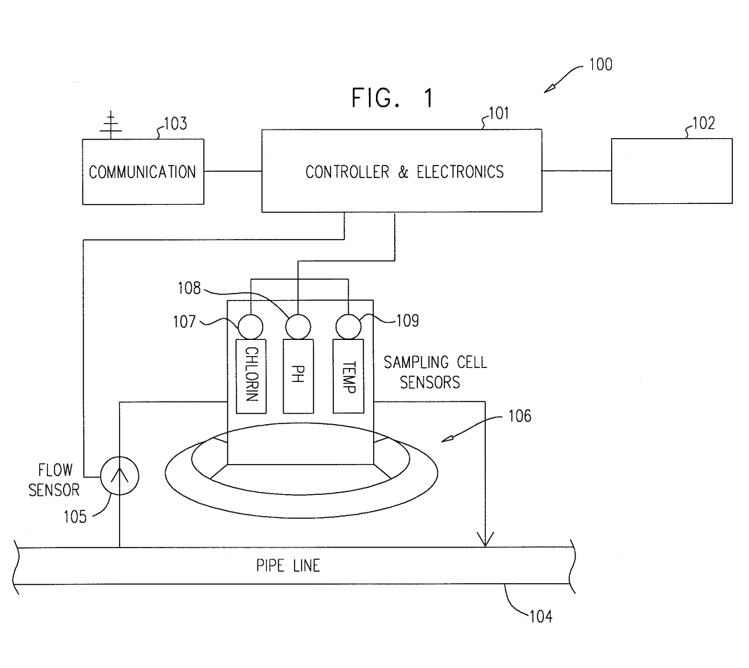

Reference is made to FIG. 1, which schematically shows a block diagram of an exemplary device 100 for monitoring water quality, in accordance with an embodiment of the invention. Device 100 is adapted to measure pH, temperature, and chlorine concentration in water conducted in a pipe line 104, and is further adapted to analyze the measurements, to store data associated with the measurements, which may include the measurements and results of performed analyses, and to output the data through a local interface and/or remote interface. Device 100 comprises a sampling cell 106, a chlorine sensor 107, a pH sensor 108, a water temperature sensor 109, a flow sensor 105, a controller including associated electronic circuitry and peripherals 101, a communications module 103, and a power module 102.

Device 100 monitoring of water quality is generally performed by diverting a portion of the water in pipe line 104 into sampling cell 106, which comprises a chlorine sensor 107, pH sensor 108, and water temperature sensor 109. Chlorine sensor 107, pH sensor 108, and water temperature sensor 109 are adapted to perform water quality measurements of the water flowing through sampling cell 106, and may be commercially available sensors. Optionally, chlorine sensor 107, pH sensor 108, and water temperature sensor 109 are adapted to perform water quality measurements of the water flowing through pipe line 104. A flow sensor 105 is adapted to measure the water flow rate into sampling cell 106 and, optionally, in pipe line 104.

Controller 101 comprises peripherals and associated control circuitry required for operating device 100, including controlling the operation of communications module 103, power module 102, and all the sensors. Controller 101 is adapted to receive measurement inputs from flow sensor 105, chlorine sensor 107, pH sensor 108, and water temperature sensor 109, to process the measurements and to perform analysis as to the quality of the water. Controller 101 is further adapted to cause device 100 to be in an active mode of operation, a sleep mode or a shut down mode, responsive to the inputs received from the sensors; to external signals from sources external to device 100; from periodic time initiations; and/or non-periodic time initiations. For convenience hereinafter, external signals from sources external to the device may be referred to as external interrupts, and periodic and non-periodic time initiations may be referred to as time interrupts. Controller 101 optionally is adapted to perform a self-test to evaluate proper operation of some, or optionally all, functions of device 100.

Communications module 103 is adapted to enable communications between device 100 and other communication devices physically located in close proximity (local interfacing) and/or distantly located (remote interfacing). Interfacing may be performed while device 100 is in the active mode.

Local interfacing between device 100 and external devices such as, for example, external controllers and/or storage mediums, may be done by means of a USB connection and/or other type of wired data transfer connection such as, for example, Ethernet connection or other LAN (local area network) connection suitable for wired data transfer. Optionally, local interfacing is done using removable storage means such as disks, flashcards, and similar. Optionally, local interfacing is done using wireless means such as, for example, a WLAN (wireless local area network). The WLAN may conform to IEEE standards 802.11 (Wireless LAN—WiFi), and/or IEEE Standards 802.15 (Wireless PAN—WPAN), the above-mentioned IEEE standards incorporated herein by reference.

Remote interfacing between device 100 and other communication devices is generally through wireless means. Communications unit 103 is adapted to remotely interface via RF communications, which may comprise direct antenna to antenna microwave links, satellite communications, cellular phone networks, and/or through a WLAN. The WLAN may conform to IEEE standard 802.16 (Broadband Wireless Access—WiMAX), 802.20 (Mobile Broadband Wireless Access—MBWA), and/or 802.22 (Wireless Regional Area Network—WRAN), or any combination thereof, the above-mentioned IEEE Standards all incorporated herein by reference. Optionally, remote interfacing is through wire communications means such as, for example, telephone lines, dedicated cables, and/or power lines.

Communications module 103 is adapted to transmit data associated with the measurements, which may include the measurements and results of performed analyses. Optionally, data transmitted may include data related to equipment operational status, and warnings/alarms related to equipment malfunction and/or to poor water quality. Communications module 103 may be further adapted to receive external interrupts, and optionally, prompts or requests for data. Optionally, communications module 103 may be adapted to receive and transfer to controller 101 reprogramming instructions/information.

Power module 102 comprises a battery package adapted to serve as a DC voltage source for powering device 100. Power module 102 may comprise non-rechargeable batteries, or optionally, rechargeable batteries. Power module 102 may optionally comprise an AC/DC voltage converter for connection of the device to power lines. Additionally or alternatively, power module 102 may be connected to a generator. Optionally, power module 102 may be connected through a USB interface for power supply from a PC, laptop computer, or other USB interface dc power supply source.

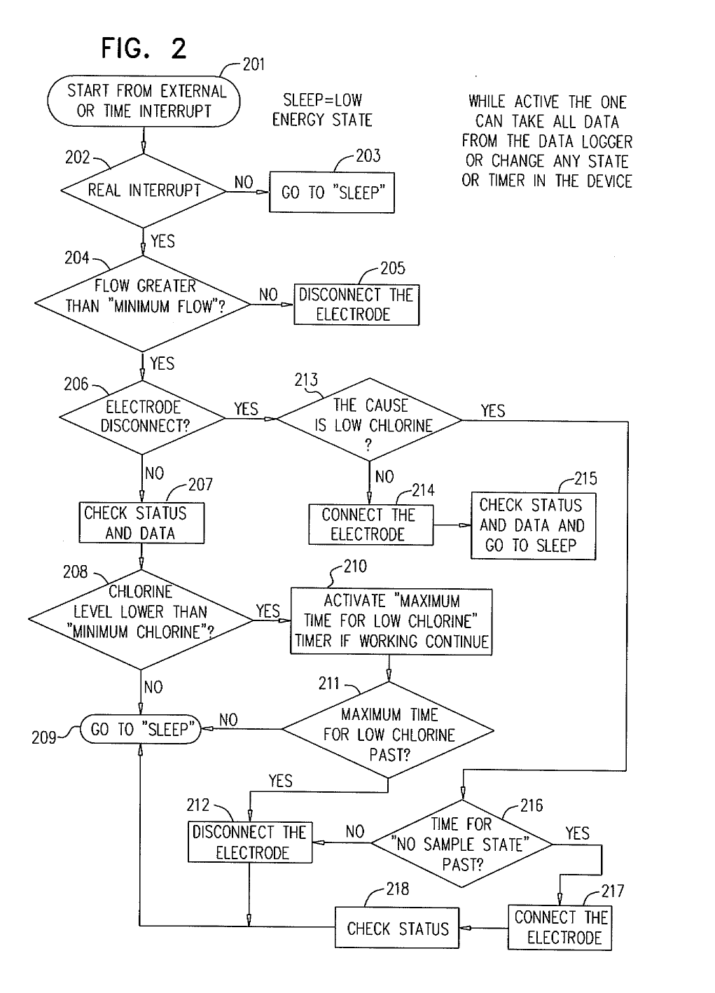

Reference is made to FIG. 2, which schematically shows a flow diagram of an algorithm for a method for using the exemplary device of FIG. 1 to measure chlorine concentration, in accordance with an embodiment of the invention. It may be appreciated by a person skilled in the art that the algorithm described below is for illustrative purposes; that there may be numerous other combinations which may be implemented in the algorithm; and that the algorithm described below is in no way intended to be limiting in any form.

[STEP 201] An interrupt signal is received by controller 101 while device 100 is in sleep mode or shut down mode. The interrupt signal may be an external interrupt received through the local interface or, alternatively, the remote interface. Optionally, the interrupt signal may be predetermined and periodic, or alternatively, non-periodic.

[STEP 202] Controller 101 verifies that the signal is an external interrupt or an internal interrupt. If the signal is not an external or an internal interrupt signal, go to STEP 203. If the signal is an external or an internal interrupt signal, go to STEP 204.

[STEP 203] Device 100 goes into sleep mode. In the sleep mode, functions in device 100 may optionally be disconnected to further reduce power consumption in addition to those disconnected in chlorine sensor 107. Electrode in chlorine sensor 107 is energized.

[STEP 204] Controller 101 processes measurement input from flow sensor to determine if water flow rate is greater than a predetermined minimum value. If water flow rate is less than or equal to the predetermined minimum value, go to STEP 205. If water flow rate is greater than the predetermined minimum value go to STEP 206.

[STEP 205] Device 100 goes into shut down mode. Power to electrode in chlorine sensor 107 is disconnected, in addition to most other functions in the sensor. In the shut down mode, functions in device 100 may optionally be disconnected to further reduce power consumption, in addition disconnecting chlorine sensor 107.

[STEP 206] Controller 101 checks if the electrode in chlorine sensor 107 is disconnected. If electrode is not disconnected go to STEP 207. If electrode is disconnected go to STEP 213.

[STEP 207] Controller 101 receives and processes measurement data from chlorine sensor 107.

[STEP 208] Controller 101 compares measured chlorine concentration in water with a predetermined minimum value. If measured chlorine concentration is equal to or greater than a predetermined minimum value, go to STEP 209. If measured chlorine concentration is less than the predetermined minimum value, go to STEP 210.

[STEP 209] Device 100 goes into sleep mode.

[STEP 210] Controller 101 compares, over a predetermined time interval (period), periodically measured chlorine concentrations in water with the predetermined minimum value.

[STEP 211] If the measured chlorine concentration is equal to or greater than the predetermined minimum value during the predetermined time interval, go to STEP 209. If the measured chlorine concentration is less than the predetermined minimum value during the predetermined time interval, go to STEP 212.

[STEP 212] Device 100 goes into shut down mode; power in chlorine sensor 107 is disconnected.

[STEP 213] Controller 101 checks if the electrode is disconnected because of previously measured low chlorine concentrations in water. If not disconnected because of previously measured low chlorine concentrations in water, go to STEP 214. If yes disconnected because of previously measured low chlorine concentrations in water, go to STEP 216.

[STEP 214] Controller 101 activates chlorine sensor 107 and energizes the electrode.

[STEP 215] Controller 101 receives and processes measurement data from chlorine sensor 107. Device 100 goes into sleep mode.

[STEP 216] Controller 101 checks if the time passed since the last measurement is greater than a predetermined time interval. If the time passed is less than the predetermined time interval, go to STEP 212. If the time passed is greater than or equal to the predetermined time interval, go to STEP 217.

[STEP 217] Controller 101 activates chlorine sensor 107 and energizes the electrode.

[STEP 218] Controller 101 receives and processes measurement data from chlorine sensor 107. Go to STEP 109.

In the description and claims of embodiments of the present invention, each of the words, “comprise” “include” and “have”, and forms thereof, are not necessarily limited to members in a list with which the words may be associated.

The invention has been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art.

1. A device for monitoring chlorine in water, the device comprising:
a chlorine sensor adapted to measure chlorine concentration in water; and
a controller adapted to facilitate conversion between an active mode and a sleep mode, wherein said conversion depends on a predetermined parameter.

2. The device of claim 1, wherein said controller is further adapted to disconnect said chlorine sensor upon receiving a signal indicative of a chlorine concentration in water at or below a predetermined value.

3. The device of claim 1, wherein said controller is further adapted to receive a second signal indicative of a chlorine concentration in water after a predetermined period of time from receiving a first signal indicative of a chlorine concentration in water at or below a predetermined value, wherein the controller is adapted to disconnect said chlorine sensor if said second signal is indicative of a chlorine concentration in water at or below a predetermined value.

4. The device of claim 1, wherein said controller is further adapted to disconnect said chlorine sensor upon receiving a signal indicative of a water flow value at or below a predetermined value.

5. The device of claim 2, wherein said controller is further adapted to connect said chlorine sensor after a predetermined period of time.

6. The device of claim 3, wherein said controller is further adapted to connect said chlorine sensor after a predetermined period of time.

7. The device of claim 1, wherein said chlorine sensor comprises a chlorine sensing electrode.

8. A device for monitoring chlorine concentration in water, the device comprising:
a chlorine sensor adapted to measure chlorine concentration in water; and
a controller adapted to disconnect said chlorine sensor upon receiving a signal indicative of a chlorine concentration in water at or below a predetermined value.

9. (canceled)

10. The device of claim 8, wherein said controller is further adapted to disconnect said chlorine sensor upon receiving a signal indicative of a water flow value at or below a predetermined value.

11. The device of claim 8, wherein said controller is further adapted to connect said chlorine sensor upon receiving a signal indicative of a water flow value above a predetermined value.

12. (canceled)

13. The device of claim 8, wherein said chlorine sensor comprises a chlorine sensing electrode.

14. A method for monitoring chlorine in water, the method comprising:
measuring chlorine concentration in water using a chlorine sensor; and
converting between an active mode and a sleep mode using a controller, wherein converting between said active mode and said sleep mode depends on a predetermined parameter.

15. The method of claim 14 and also comprising disconnecting the chlorine sensor upon receiving a signal indicative of a chlorine concentration in water at or below a predetermined value.

16. The method of claim 14 and also comprising disconnecting the chlorine sensor upon receiving a second signal indicative of a chlorine concentration in water at or below a predetermined value, after a predetermined period of time from receiving a first signal indicative of a chlorine concentration in water at or below a predetermined value.

17. The method of claim 14 and also comprising disconnecting the chlorine sensor upon receiving a signal indicative of a water flow value at or below a predetermined value.

18. The method of claim 15 and also comprising connecting the chlorine sensor upon receiving a signal indicative of a water flow value above a predetermined value.

19. The method of claim 16 and also comprising connecting the chlorine sensor after a predetermined period of time.

20. The method of claim 14, wherein said chlorine sensor comprises a chlorine sensing electrode.

21-26. (canceled)
